(19) United States
(12) Patent Application Publication
(10) Pub. No.: US 2023/0249949 A1
(43) Pub. Date: Aug. 10, 2023

(54) GRIPPER STRUCTURE FOR LARGE-SIZED TONG

(71) Applicant: Young Suk NAM, Daegu-si (KR)

(72) Inventor: Young Suk NAM, Daegu-si (KR)

(21) Appl. No.: 17/873,497

(22) Filed: Jul. 26, 2022

(30) Foreign Application Priority Data
Feb. 7, 2022 (KR) 10-2022-0015628

(51) Int. Cl. B66C 1/58

(52) U.S. Cl. CPC B66C 1/58

(57) ABSTRACT

A gripper structure for large-sized tongs used to grip an object such as timber, steel, steel scrap, waste, and the like and lift it, and more specifically, to a gripper structure for large-sized tongs that is capable of dividing each of fixed gripper plates of a fixed gripper into two parts and coupling reinforcement plates on both sides of the divided parts, respectively, by means of bolts and nuts, thereby conveniently making the fixed gripper and improving the durability of the fixed gripper plates.

### CROSS REFERENCE TO RELATED APPLICATION OF THE INVENTION

The present application claims the benefit of Korean Patent Application No. 10-2022-0015628 filed in the Korean Intellectual Property Office on Feb. 7, 2022, the entire contents of which are incorporated herein by reference.

### BACKGROUND OF THE INVENTION

### Field of the Invention

The present invention relates to a gripper structure for large-sized tongs used to grip an object such as timber, steel, steel scrap, waste, and the like and lift it, and more specifically, to a gripper structure for large-sized tongs that is capable of dividing each of fixed gripper plates of a fixed gripper into two parts and coupling reinforcement plates on both sides of the divided parts, respectively, by means of bolts and nuts, thereby conveniently making the fixed gripper and improving the durability of the fixed gripper plates.

### Background of the Related Art

As shown in FIGS. 1 and 2, a conventional tong gripper structure includes a fixed gripper having ‘└’-shaped fixed gripper plates, a movable gripper having ‘┐’-shaped movable gripper plates connected to tops of the fixed gripper plates by means of hinges, and actuators disposed between fixed gripper connectors and movable gripper connectors and operating with a fluid pressure to open and close the movable gripper.

The conventional tong gripper structure is configured to have the fixed gripper with the ‘└’-shaped fixed gripper plates spaced apart from one another and to allow support rods to be connected to tops, curved portions, and front ends of the fixed gripper, respectively, to thus provide the fixed gripper as one unit. In this case, however, a lot of portions have to be welded to thus cause the manufacturing time to be undesirably extended, and the conventional tong gripper structure has a heavy body with a large volume, thereby requiring a relatively large work space.

### SUMMARY OF THE INVENTION

Accordingly, the present invention has been made in view of the above-mentioned problems occurring in the related art, and it is an object of the present invention to provide a gripper structure for large-sized tongs that is capable of dividing each of fixed gripper plates of a fixed gripper into two parts and coupling reinforcement plates on both sides of the divided parts, respectively, by means of bolts and nuts, thereby conveniently making the fixed gripper and improving the durability of the fixed gripper plates.

To accomplish the above-mentioned objects, according to the present invention, there is provided a gripper structure for large-sized tongs that is configured to allow the intermediate portion of the bottom of each of ‘└’-shaped fixed gripper plates to be cut in a vertical direction and divided into an inner gripper plate and an outer gripper plate and to couple reinforcement plates to both sides of the divided parts by means of bolts and nuts, so that a gripping and lifting work may be performed even after the inner gripper plates and the outer gripper plates are separated from each other, and the divided parts of the fixed gripper plates may be coupled to each other after the work is finished, thereby ensuring easiness in the work and improving the rigidity of the fixed gripper plates.

### BRIEF DESCRIPTION OF THE DRAWINGS

The above and other objects, features and advantages of the present invention will be apparent from the following detailed description of the embodiments of the invention in conjunction with the accompanying drawings, in which:

FIG. 1 is a perspective view showing a conventional tong gripper structure;

FIG. 2 is an exploded sectional view showing the conventional tong gripper structure of FIG. 1;

FIG. 3 is a perspective view showing a gripper structure for large-sized tongs according to the present invention;

FIG. 4 is an exploded sectional view showing the gripper structure of FIG. 3;

FIG. 5 is an enlarged view showing connectors of a fixed gripper plate of the gripper structure according to the present invention;

FIG. 6 is an exploded sectional view showing the gripper structure of FIG. 4; and

FIGS. 7A to 7C are perspective views showing examples of a coupling portion of the fixed gripper plate according to the present invention.

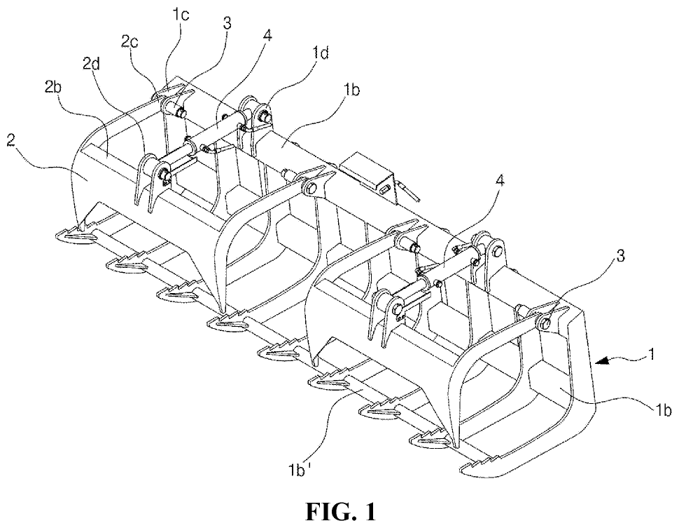

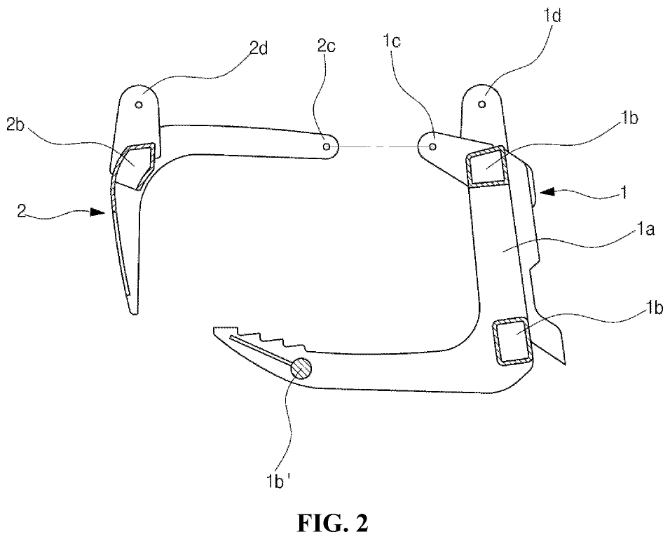

### DETAILED DESCRIPTION OF THE EMBODIMENTS

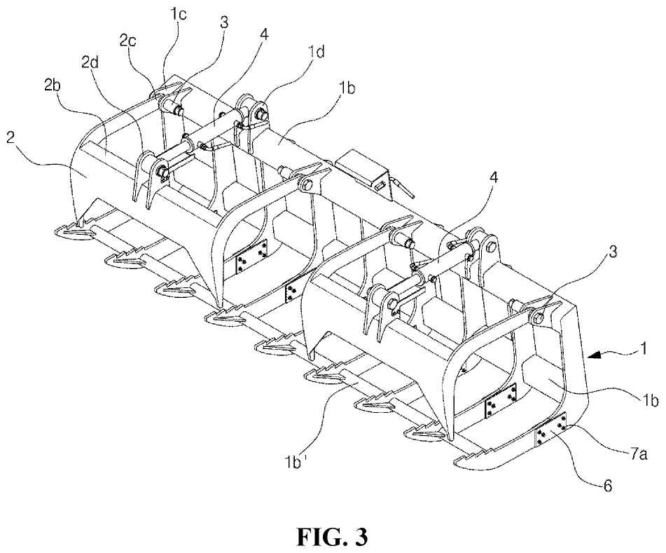

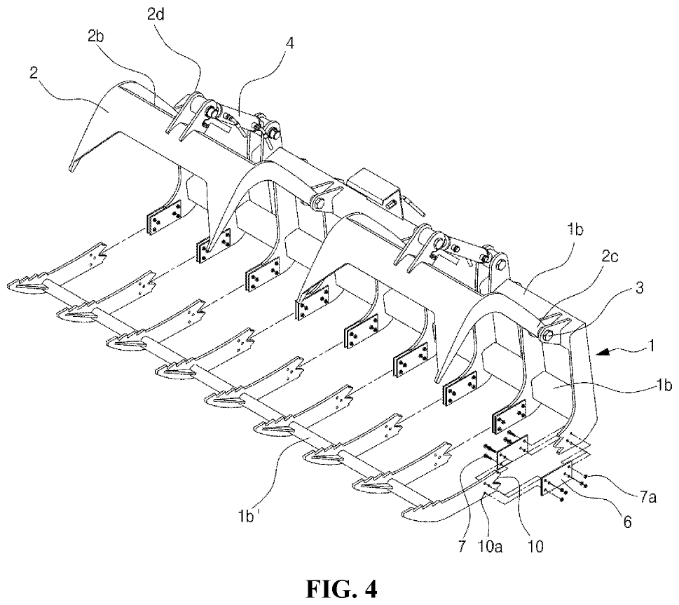

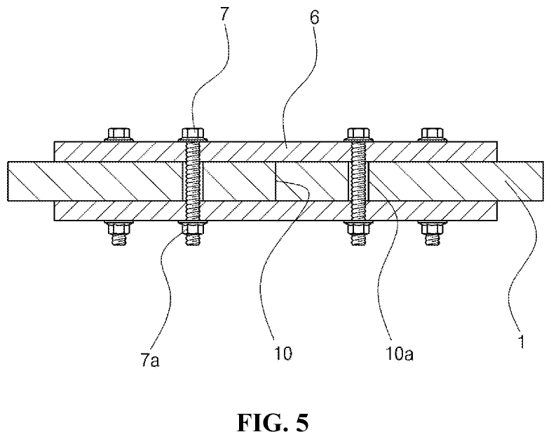

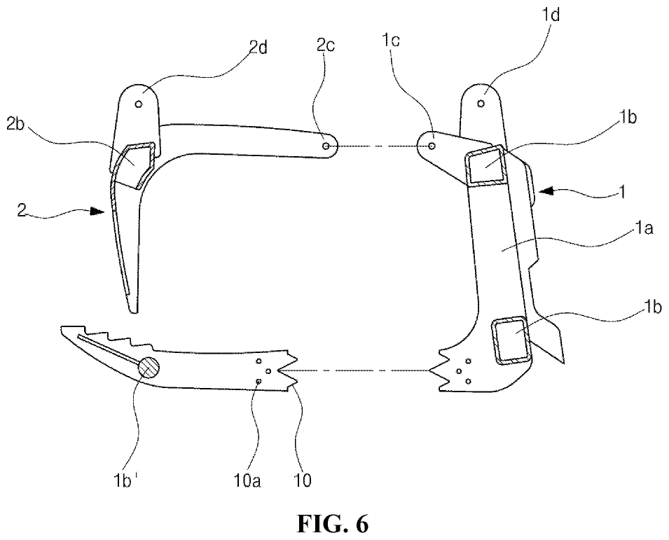

As shown in FIGS. 3 to 6, large-sized tongs according to the present invention include: a fixed gripper 1 having ‘└’-shaped fixed gripper plates 1a spaced apart from one another, support rods 1b for fitting the fixed gripper plates 1a thereto, and connection pieces 1c disposed on the front surface of the upper support rod 1b; a movable gripper 2 having ‘┐’-shaped movable gripper plates 2a spaced apart from one another, a support rod 2b for fitting the movable gripper plates 2a thereto, and connection pieces 2c connected to the connection pieces 1c of the fixed gripper 1 by means of hinge shafts 3; and actuators 4 disposed between protruding support pieces 1d protruding from the upper support rod 1b of the fixed gripper 1 and protruding support pieces 2d protruding from the support rod 2b of the movable gripper 2, respectively, to open and close the movable gripper 2.

According to the present invention, the gripper structure is configured to allow the intermediate portion of the bottom of each fixed gripper plate 1a to be cut in a vertical direction and thus divided into two parts, to drill bolt holes 10a on the divided parts 10, respectively, and to couple reinforcement plates 6 to both sides of the divided parts 10, respectively, by means of bolts 7 and nuts 7a fitted to the bolt holes 10a, thereby providing one fixed gripper plate 1a.

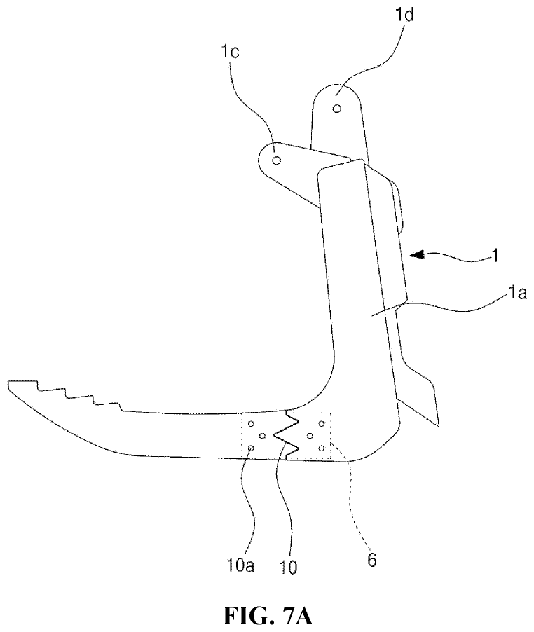

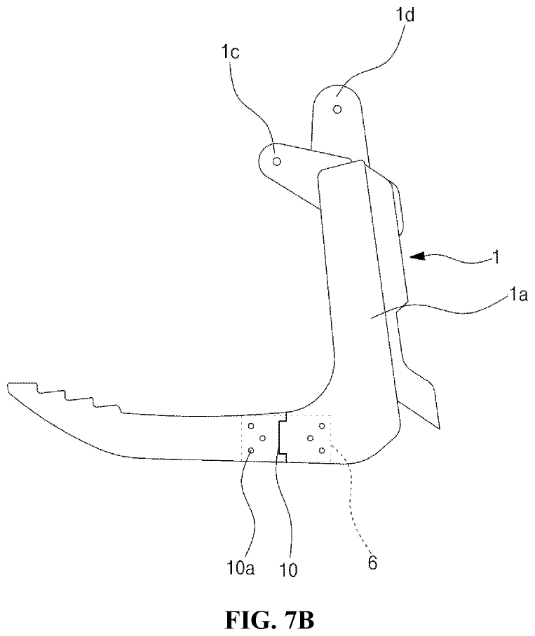

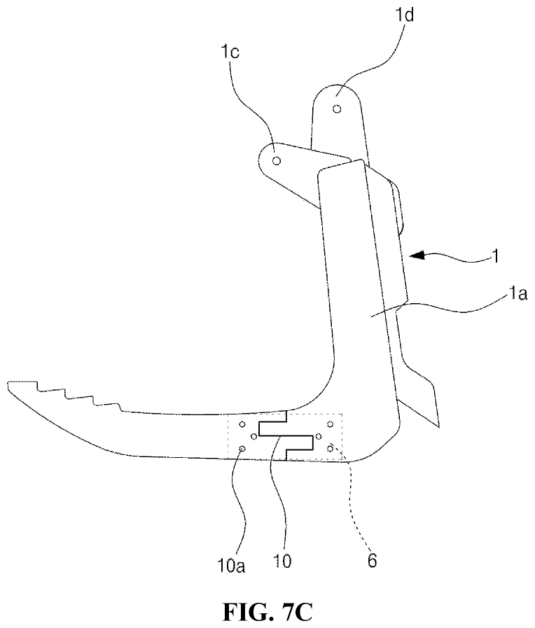

As shown in FIGS. 7A to 7C, the divided parts 10 of each fixed gripper plate 1a are connected to each other by means of toothed coupling or protrusion and groove coupling so that their coupled surfaces become increased to enhance their coupling rigidity.

As described above, the gripper structure for large-sized tongs according to the present invention can allow the intermediate portion of the bottom of each ‘└’-shaped fixed gripper plate to be cut in the vertical direction and thus divided into the inner gripper plate and the outer gripper plate.

In addition, the gripper structure for large-sized tongs according to the present invention can provide the division type fixed gripper in which tops and curved portions of the inner gripper plates are welded to the two support rods 1b in parallel with each other and intermediate portions of the outer gripper plates are welded to the support rod 1b′, so that the fixed gripper may be made dividedly to thus have a smaller volume than a volume before divided, thereby making it convenient to handle it.

Moreover, the gripper structure for large-sized tongs according to the present invention can occupy a relatively small work space, reduce the occurrence of safety accidents during the work, provide easy management of working labors, shorten the manufacturing time, and lowering the manufacturing cost.

Further, the gripper structure for large-sized tongs according to the present invention can move and keep the fixed gripper conveniently because the divided parts are separated from each other and can couple the reinforcement plates to both sides of the divided parts, respectively, by means of the bolts and nuts to connect the divided parts to each other, thereby improving the rigidity of the fixed gripper.

As a result, the gripper structure for large-sized tongs according to the present invention can enhance work efficiency, thereby making it possible to be made in mass.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A gripper structure for large-sized tongs having a fixed gripper (1) having ‘└’-shaped fixed gripper plates (1a) spaced apart from one another, upper and lower support rods (1b) for fitting the fixed gripper plates (1a) thereto, and connection pieces (1c) disposed on the front surface of the upper support rod (1b), a movable gripper (2) having ‘┐’-shaped movable gripper plates (2a) spaced apart from one another, a support rod (2b) for fitting the movable gripper plates (2a) thereto, and connection pieces (2c) connected to the connection pieces (1c) of the fixed gripper (1) by means of hinge shafts (3), and actuators (4) disposed between protruding support pieces (1d) protruding from the upper support rod (1b) of the fixed gripper (1) and protruding support pieces (2d) protruding from the support rod (2b) of the movable gripper (2), respectively, to open and close the movable gripper (2), the gripper structure comprising:
divided parts (10) made by cutting the intermediate portion of the bottom of each fixed gripper plate (1a) in a vertical direction; and
reinforcement plates (6) coupled to both sides of the divided parts (10), respectively, by means of bolts (7) and nuts (7a) fitted to bolt holes (10a) formed on the divided parts (10), to provide one fixed gripper plate (1a).

2. The gripper structure according to claim 1, wherein the divided parts (10) of each fixed gripper plate (1a) are connected to each other by means of toothed coupling or protrusion and groove coupling so that the coupled surfaces between the divided parts (10) become increased.
